(19) United States
(12) Patent Application Publication
(10) Pub. No.: US 2015/0143717 A1
(43) Pub. Date: May 28, 2015

(54) SHOELACE RETENTION DEVICES

(71) Applicant: CLIPZEEZ, INC., Santa Barbara, CA (US)

(72) Inventor: LUKE BILLINGS, Ventura, CA (US)

(21) Appl. No.: 14/504,246

(22) Filed: Oct. 1, 2014

Related U.S. Application Data
(60) Provisional application No. 61/886,495, filed on Oct. 3, 2013.

(51) Int. Cl. A43C 7/00; G09F 3/04; G09F 23/00; A43C 7/04

(52) U.S. Cl. CPC A43C 7/005; A43C 7/04; G09F 3/04; G09F 23/00
USPC 36/83; 24/712.2; 24/303; 40/642.02

(57) ABSTRACT

Lace retention devices are disclosed that can safely and conveniently hold looped laces in place, while also being aesthetically pleasing. One embodiment of a lace retention device according to the present invention comprises an arm and a holding mechanism integral to one end of the arm. A housing is also included that is integral to the arm at an end opposite the holding mechanism with the housing being sized and shaped to hold looped footwear laces.

This application claims the benefit of U.S. Provisional Patent Application No. 61/886,495, filed on Oct. 3, 2013.

### BACKGROUND OF THE INVENTION

1. Field of the Invention

This invention relates to footwear and in particular to shoelace retention devices for footwear.

2. Description of the Related Art

Laces have been used with all types of footwear for hundreds of years, and have been arranged in different ways to close and fit the particular type of footwear around to foot and to hold the footwear in place on the foot. This lacing arrangement can be used with sandals, work footwear, sneakers, formal footwear, etc.

Almost from the beginning, one of the laces was run through holes in opposing pieces of the footwear, with the end of the lace available for grasping by the user. Once the footwear is placed on a foot in the desired position, and the ends of the laces can be grasped and pulled to tighten the footwear in place on the foot. The ends of the laces can then be tied in a knot to hold the footwear on the foot.

One of the problems with conventional laces is that when tied, there are lace loops that protrude from the knot, typically in different directions. This can result in an unsightly and sloppy look to the footwear. Also the loops can get caught on the other piece of footwear or on other objects when walking, which can cause the loops to come undone from the knot. This can result in the footwear coming loose and requiring the laces to again be tightened and tied in a knot.

If the loops are too long or come undone, they can also result in tripping dangers and health hazards. It is generally known the long loops or ends of the laces that extend to the ground can present a danger of tripping. Furthermore, these extended loops or laces can drag on the ground where they can become dirty or contaminated. These can then be transferred to the user's hands the next time that the laces are tied.

Known prior art devices for securing shoelaces include those disclosed in U.S. Pat. No. 4,805,270; U.S. Pat. No. 4,884,321; U.S. Pat. No. 5,119,539; U.S. Pat. No. 5,158,428; U.S. Pat. No. 4,514,882; U.S. Pat. No. 5,924,177

### SUMMARY OF THE INVENTION

The present invention is directed to lace retention devices that can safely and conveniently hold looped laces in place, while also being aesthetically pleasing. One embodiment of a lace retention device according to the present invention comprises an arm and a holding mechanism integral to one end of the arm. A housing is also included that is integral to the arm at an end opposite the holding mechanism with the housing being sized and shaped to hold looped footwear laces.

The present invention is also directed to laced footwear with one embodiment comprising a lace crossed between portions of the footwear to hold the footwear on a foot. A lace retention device is included to hold looped portions of the lace, with the device comprising a holding mechanism to hold the device to one of the crossed sections of said lace. The device also includes a housing coupled to the holding mechanism, with the housing having a hollow portion sized and shaped to hold the looped portions of the lace.

The present invention is also directed to a lace retention device having portions that can conveniently display a sport or product logos. One embodiment of a logo display device is particularly arranged for mounting to a lace retention device and a flat surface for displaying numbers, letters or a logo. The display device also comprises a mechanism for mounting to a lace retention device on footwear such that the numbers, letters or logo are visible.

These and other aspects and advantages of the invention will become apparent to those skilled in the art from the following detailed description and the accompanying drawings, which illustrate by way of example the features of the invention.

### BRIEF DESCRIPTION OF THE DRAWINGS

FIG. 1 is a top view of one embodiment of a lace retention device according to the present invention;

FIG. 2 shows is a side view of the lace retention device shown in FIG. 1;

FIG. 3 is a bottom view of the lace retention device shown in FIG. 1;

FIG. 4 is an exploded view of the retention device shown in FIG. 1;

FIG. 5 is a side view of the upper portion of the housing used in the retention device of FIG. 1;

FIG. 6 is a bottom view of the upper portion shown in FIG. 5;

FIG. 7 is a top view of a shoe using a lace retention device according to the present invention;

FIG. 8 is another top view of a show using a lace retention device according to the present invention;

FIG. 9 is a top view of another embodiment of a lace retention device according to the present invention;

FIG. 10 is an exploded view of another embodiment of a lace retention device according to the present invention;

FIG. 11 is a top view of another embodiment of a lace retention device according to the present invention;

FIG. 12 is side view of the lace retention device shown in FIG. 11;

FIG. 13 is another side view of the lace retention device shown in FIG. 11;

FIG. 14 is a perspective view of another embodiment of a retention device according to the present invention;

FIG. 15 is a perspective view of the lower portion in the retention device shown in FIG. 14;

FIG. 16 is a perspective view of the upper portion in the retention device of FIG. 14;

FIG. 17 is a sectional view of the housing shown in FIG. 14, taken along section lines 17-17;

FIG. 18 is a sectional view of a portion of the housing shown in FIG. 17;

FIG. 19 is a perspective view of another embodiment of a retention device according to the present invention;

FIG. 20 is a perspective view of the upper portion in the retention device shown in FIG. 19;

FIG. 21 is a perspective view of the lower portion in the retention device of FIG. 19;

FIG. 22 is a perspective view of still another embodiment of a retention device according to the present invention;

FIG. 23 is a perspective view of the upper portion in the retention device shown in FIG. 22; and

FIG. 24 is a perspective view of the lower portion in the retention device of FIG. 22.

### DETAILED DESCRIPTION OF THE INVENTION

The present invention is directed to different embodiments of a shoelace or lace retention device used primarily with different types of footwear and shoes that have laces. The devices can be used for all different types of footwear, both youth and adult, and are arranged to keep tied shoelaces in place on the shoe so that they remain tied and do not fall to the ground. Some embodiments of shoelace retention devices according to the present invention are shown in the attached drawings. It is understood that these are only some of the possible embodiments, and other embodiments can have different shapes, sizes and colors and can have different features. Accordingly, the present invention should not be construed as limited to the embodiments set forth herein.

The embodiments below are described with reference to retaining laces in footwear, but it is understood that present invention can also be applied in other clothing or devices having laces. For example, retaining devices according to the present invention can be used with sweatshirts, bags, backpacks, etc. that have laces. It is understood that the use of the term laces or shoelaces should not be construed as limiting to footwear and that the present invention can also be used for in many different applications, such as any using strings or ropes.

It is also understood that when an element, piece or portion of the devices according to the present invention are referred to as being “on” or “connected” to another element, piece or portion, they can be directly on or connected the other element or intervening elements may also be present. Furthermore, relative terms such as “inner”, “outer”, “upper”, “above”, “lower”, “beneath”, and “below”, and similar terms, may be used herein to describe relationship between different features. It is understood that these terms are intended to encompass different orientations of the device in addition to the orientation depicted in the figures.

Embodiments of the invention are described herein with reference to different view illustrations that are schematic illustrations of embodiments of the invention. As such, the actual thickness of the layers can be different, and variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing. A region illustrated or described as square or rectangular will typically have rounded or curved features due to normal manufacturing tolerances. Thus, the regions illustrated in the figures are schematic in nature and their shapes are not intended to illustrate the precise shape of a region of a device and are not intended to limit the scope of the invention.

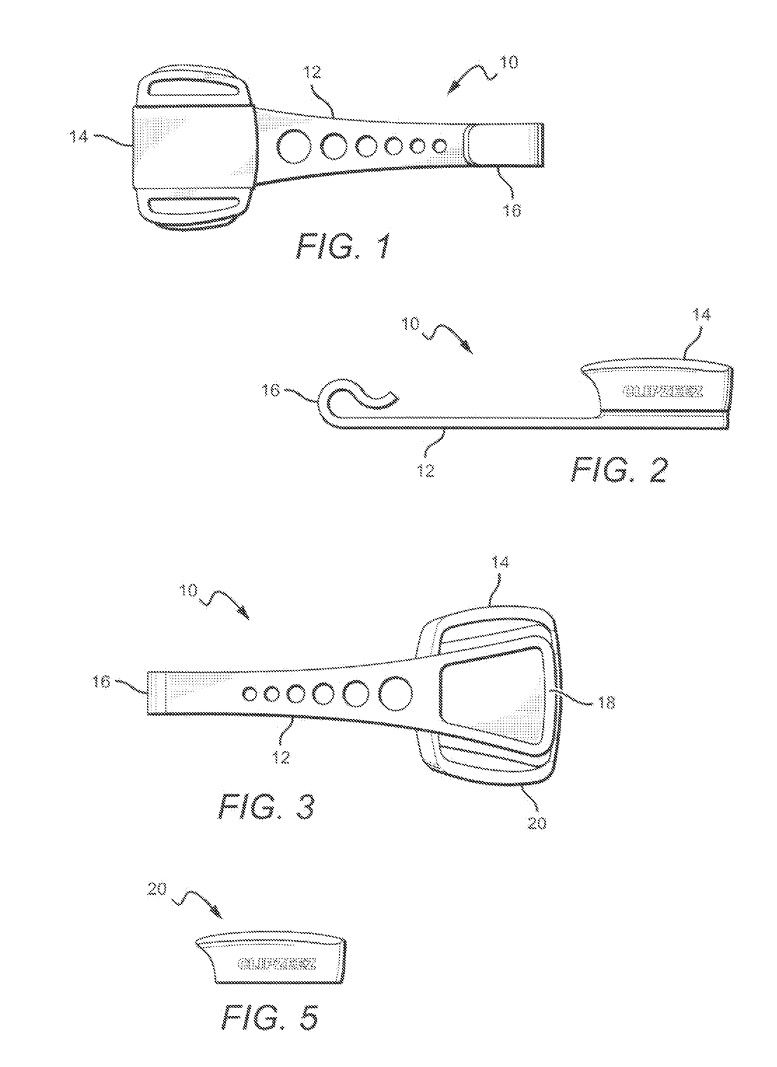

FIGS. 1-4 show one embodiment of a lace retention device 10 according to the present invention. The devices according to the present invention can be made of many different materials, with some be made of a durable of rigid material such as polypropylene plastic. The different embodiments can be arranged in many different ways with different numbers of pieces. In some embodiments, the device consists of two primary pieces, the arm 12 and the housing 14 for holding the tied laces. The arm 12 can be substantially flat and arranged such that is lays flat on the tongue of the shoe and underneath the crisscrossing laces when installed on the footwear as described in more detail below. The housing 14 is arranged at one end of the arm 12, with the opposite end of the arm 12 comprising a holding mechanism 16 for holding the retention device 10 in place under the laces. In the embodiment shown, the holding mechanism 16 can comprise a hook that is sized and located to engage with one of the laces to hold the device in place. It is understood that many other different holding mechanisms can be used such as snaps, buttons, Velcro®, or a thick end portion that protrudes into the laces to hold the device in place.

The housing 14 is located at the end of the arm 12 opposite the holding mechanism 16, with the housing arranged and sized to hold the loops of laces once the laces are tied. The housing 14 can come in many different sizes and can comprise many different shapes; circular, oval, square, rectangular, diamond, or any other polygon shape. The housing 14 can be at least partially hollow and can comprise different number of pieces arranged for opening to allow the looped laces to be placed in the housing, and for closing to hold the looped laces in place. In other embodiments, the housing 14 can comprise an opening to allow for the looped laces to be fed through the hollow portion of the housing to hold the looped laces.

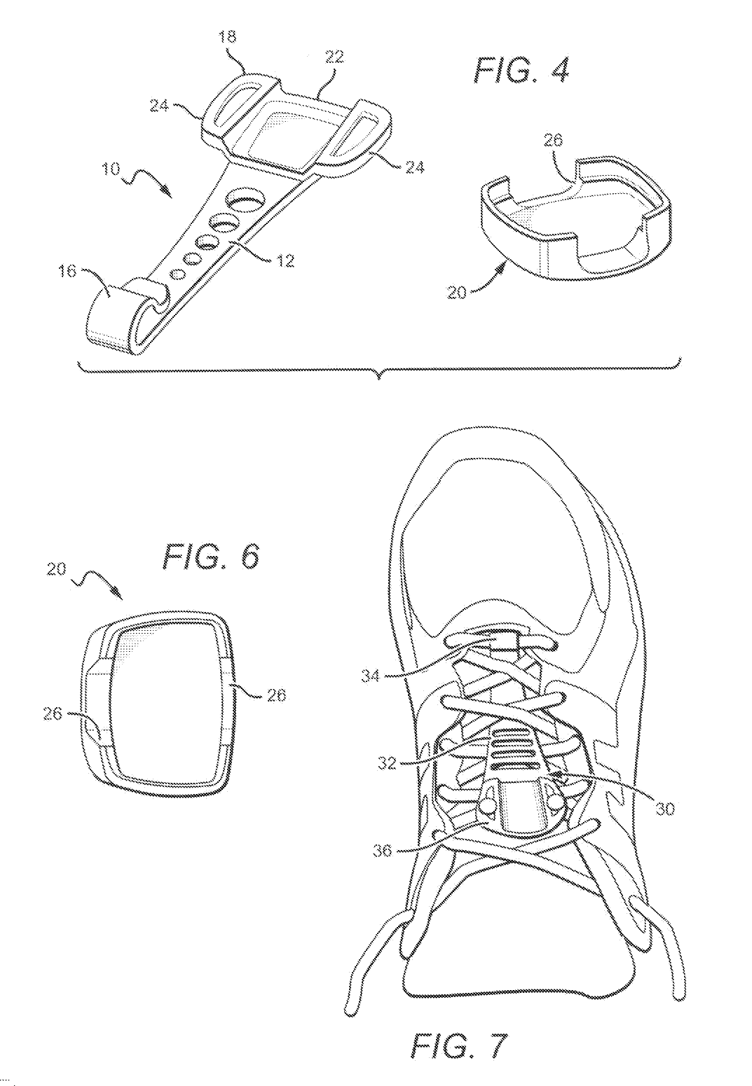

As best shown in FIGS. 4-6, one embodiment of the housing 14 can comprise a housing lower portion 18 and a housing upper portion 20. The lower portion 18 can comprise a hollow portion in the form of a channel 22 that is aligned with the longitudinal axis of the arm 12. The lower portion 18 can also comprise opposing raised tabs 24 along the sides of the channel 22, with the inner edges of the tabs 24 forming the sides of the channel 22. When the device 10 is in use, the loops of the tied laces are placed in the channel 22.

The upper portion 20 is generally hollow and is sized to fit over the lower portion 18. The upper portion 20 can be held in place on the lower portion in many different ways, with the embodiment shown having ridges on the inside surface of the upper portion 20 that allows for the upper portion to snap in place over the lower portion. The upper portion has side openings 26 located to align with the upper and lower openings of the channel 22 so the when the upper portion is mounted on place, an opening is provided through the upper portion 20 and though the channel 20. When the device is in use and the loops are placed in the lower portion 18, the upper portion 20 snaps in place over the lower portion 18 to hold the loops in the housing 14.

It is understood that the housing can be arranged in many different ways. The bottom and top portion can be attached by a hinge that allows for the housing unit to open and close a clam-shell manner. The edge of the top opposite the hinge can have a clip, magnet of Velcro® to hold the top portion in place on the bottom portion. In other embodiments, the top portion can be a separate piece the snaps in place over the bottom portion, or slides in place on rails on the bottom portion. Still other embodiments can have a mechanism that allows for the top portion to twist in place on bottom portion. Some of these other embodiments are described below, and these are just some of the many attachments mechanisms that can be used in the different embodiments of the present invention.

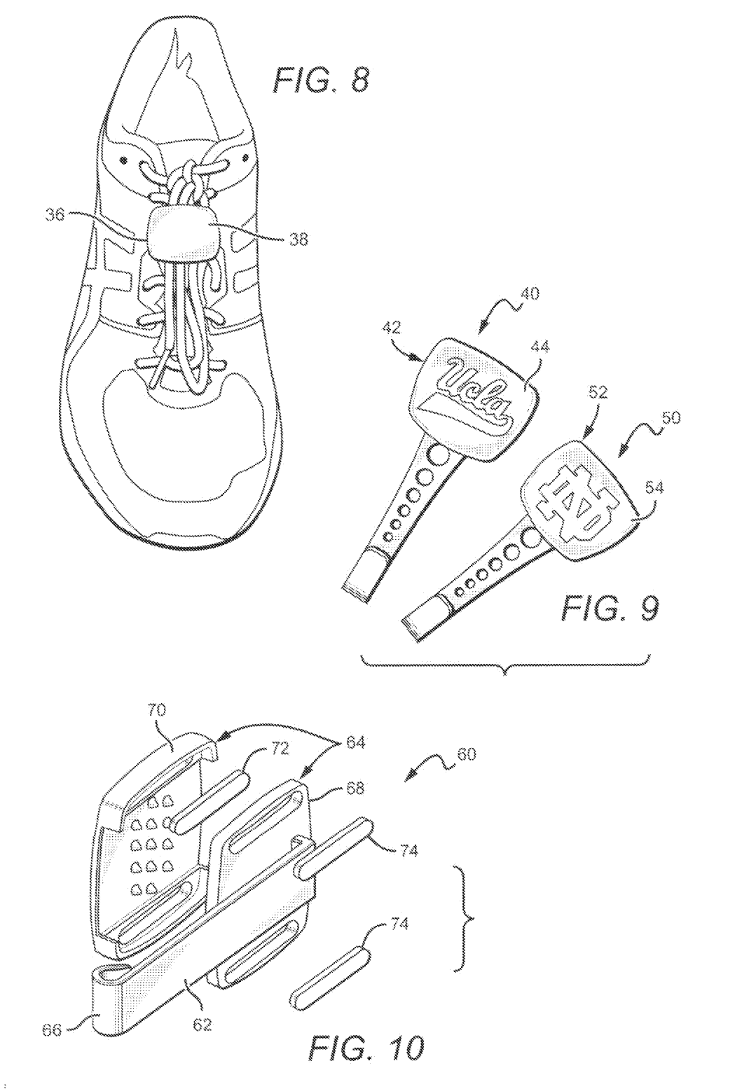

FIGS. 7 and 8 show one embodiment of a retention device 30 in use on the laces of a shoe. The arm 32 is fed under crossing laces so that at least part of it rests against the tongue of the shoe. The attachment mechanism 34 can then be used to attach the device 30 to the laces, and in the embodiment shown the attachment mechanism comprises a hook as described above. The attachment mechanism 34 can be attached to the lowest portion of the crossing laces as shown, or can be attached to one of the intermediate crossing portions. The device 30 is shown in FIG. 7 without the housing upper portion described above, with only the housing lower portion 36 shown.

Referring now to FIG. 8, once a user ties the laces in a knot, the two loops of the laces are then laid flat into the channel of the lower portion 36. The upper portion 38 is then mounted to the lower portion 36 as described above to hold the laces in place. The underside of the upper portion 38 can have features to help hold the laces in the channel such as ribs, dimples, texturing or other protrusions into the channel.

The devices according to the present invention have a number of benefits as described above. One benefit is that the devices secure the shoe laces in place and held keep them from becoming untied. Another benefit is that the devices keep the laces tied and secure, which prevents them from touching the ground. This in turn helps keep the clean and free from dirt, bacteria and germs often absorbed or picked up by untied shoe laces. Another benefit is the aesthetics it provides to the look of each individual shoe. The devices can be very stylish and keeping the laces hidden and laying flat will provide each shoe with an overall better look. The devices are also time savers and can reduce the hassles associated with laced shoes. The user will no longer have to continually be retying shoes. You tie your shoes one time and the devices according to the present invention allow you to not have to worry about tying them over and over again.

The devices according to the present invention can also comprise a surface that is particularly arranged for displaying of name or logos, such as sports or product logos. FIG. 9 shows two embodiments of devices 40 and 50 that are similar to the embodiments described above. Each comprises a respective housing 42, 52, with each housing having an upper portion 44, 54. The upward facing surface of each upper portion 44, 54 provides a flat surface for printing team or product logos, with the flat surface being visible when the device is mounted on the laces of a shoe.

It is understood that the devices according to the present invention can be arranged differently than those described above. The materials according to the present invention can be many different colors, and some can be clear or transparent. On different embodiments, the arm can have different lengths and can attach in many different ways. In other embodiments, the device can be arranged inverted to the orientation above, such that the holding mechanism is closer to the top of the crossed laces (i.e. closer to the knot) with the housing below. The arm can have many different hole arrangements down its length that can be aesthetic, and some which can be functional such as to allow for arm flexibility.

FIG. 10 shows another embodiment of retention device 60 according to the present invention also comprising an arm 62, a housing 64, and a holding mechanism 66. Like the embodiment above, the holding mechanism 66 comprises a hook, but other holding mechanisms can be used as described above. Also like the embodiments above, the housing 64 comprises lower and upper portions 68, 70. However, in this embodiment the lower and upper portions 68, 70 are held together by upper magnets 72 arranged on the upper portion 68 and lower magnets 74 arranged on the lower portion 70. When the upper portion 68 is placed over the lower portion 70 to hold laces in the housing 64, the magnetic force between the upper and lower magnets 72, 74 hold the upper and lower portions 68, 70 in place. It is understood that the magnets can be used with other upper and lower portion mounting arrangements, such as those described above. The upper portion 68 also comprises dimples 76 on its lower surface that are arranged to engage to the laces to hold the laces in the housing 64.

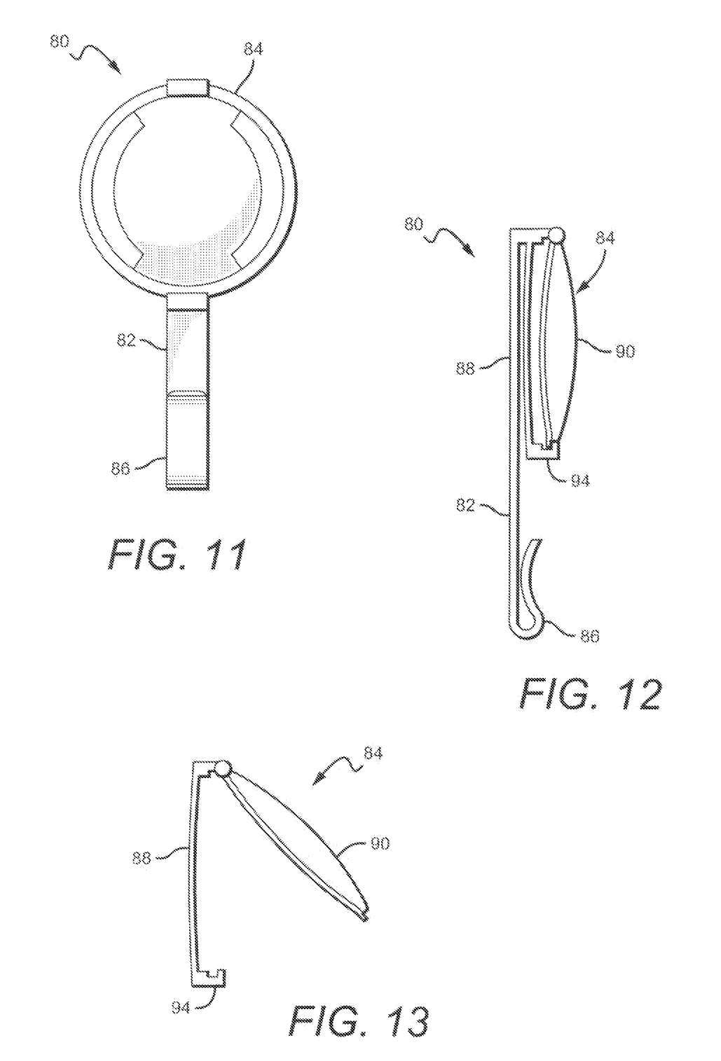

FIGS. 11-13 show another embodiment of a retention device 80 according to the present invention that can also comprise and arm 82, housing 84 and holding mechanism 86. Like above, the holding mechanism 86 can be many different mechanisms, with the embodiment shown being a hook. The housing 84 is circular shaped and does not comprises upper and lower portions 88, 90 similar to above. However, in this embodiment, the lower and upper portions 88, 90 are connected by a hinge 92. This allows for the upper portion 90 to rotate away from the lower portion 88 about the hinge 92 to open the housing 84. This allows for the laces to be placed in the housing 84. Thereafter, the upper portion 90 can be rotated back to a closed position over the lower portion 88, with the upper portion being held closed by snapping in place at the wall 94. The housing 84 is arranged to that this opening and closing action can be accomplished by hand. It is understood that this is only one of the ways to hold the upper and lower portions together and that other embodiments can also use magnets as described above. Many different hinge arrangements can also be used, the one embodiment using a thin section of material used for the housing 84.

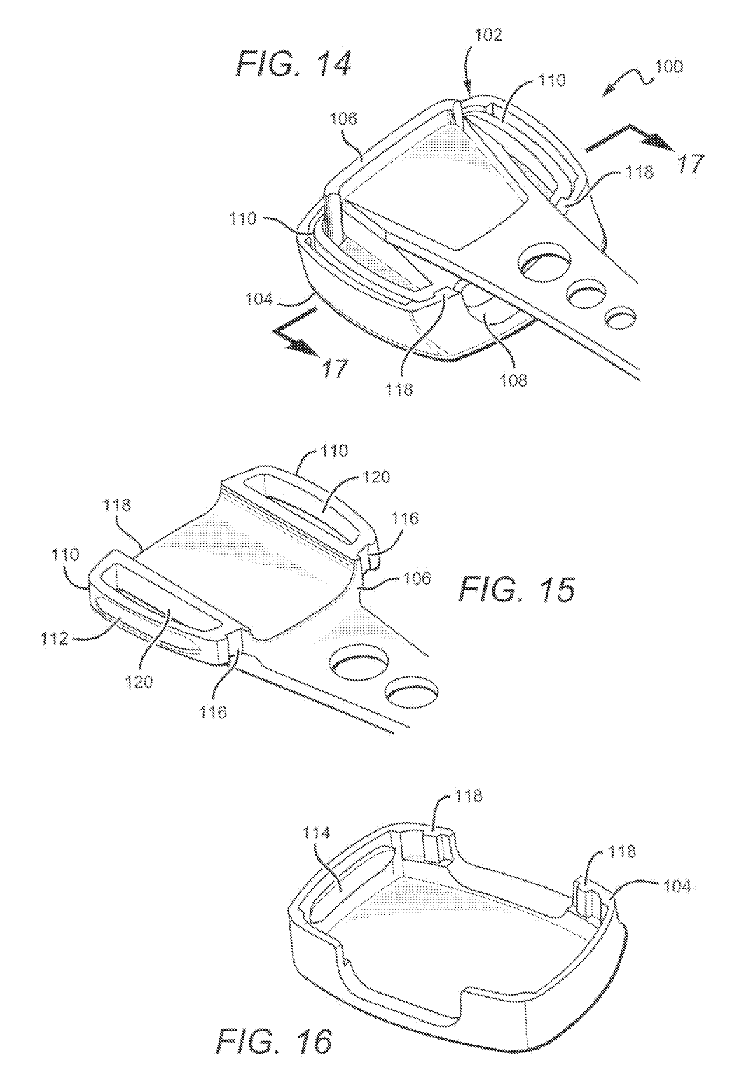

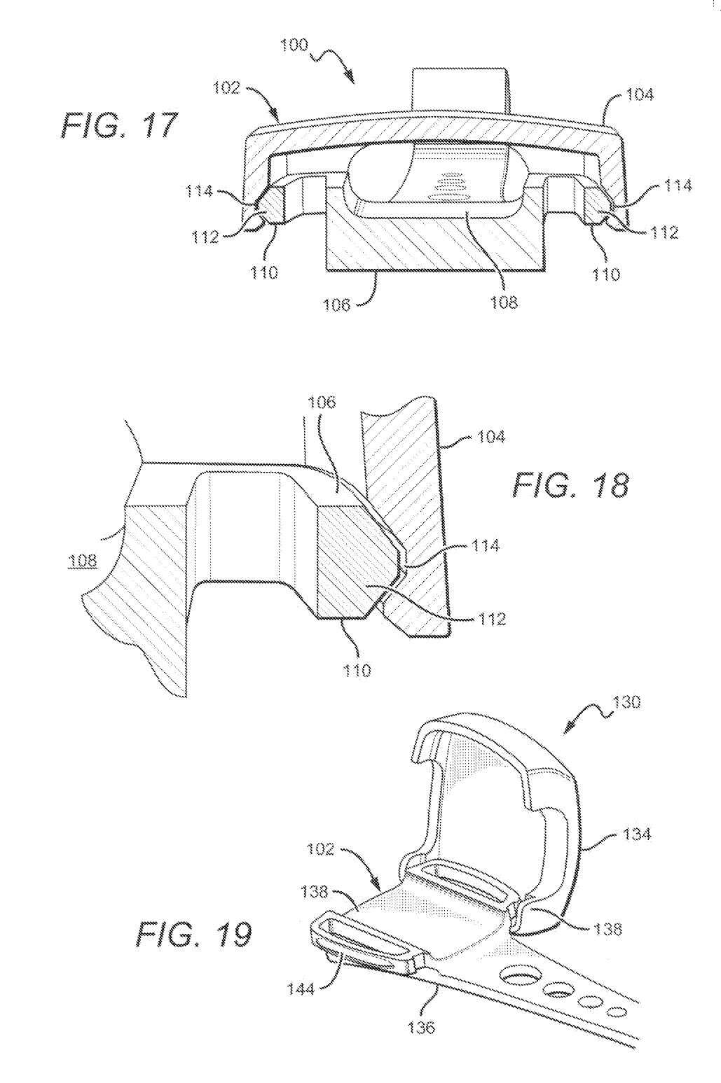

As mentioned above, the upper portion of the housing can be mounted to or connected to the lower portion using many different arrangements. FIGS. 14-18 show one embodiment of a retention device 100 having a housing 102 with upper and lower potions 104, 106 mounted together and forming a channel 108 for the laces. The upper and lower portions 104, 106. Similar to the embodiment described above, the lower portion 106 has tabs 110 that engage with the upper portion 104 to hold the upper and lower portions 104, 106 together. In this embodiment, each of the tabs 110 has a first ridge 112, each of which engages with a respective first slot 114 in the upper portion 104. Each of the tabs 110 also has a second slot 116 arranged to mate with a second tab 118 in the upper portion 104. In this embodiment, the first tabs and slots 112, 114 are arranged orthogonal to the second tabs and slots 116, 118, and this multiple tab/slot arrangement can provide a more robust mounting of the upper portion 104 to the lower portion 106. This can help avoid the upper portion from being accidentally knocked from its position on the lower portion. It is noted that each of the tabs 110 has an opening 120, which can allow for greater flex in the tab when mounting. This can make the mounting of the upper and lower portions easier, while at the same time providing improved holding strength between the two.

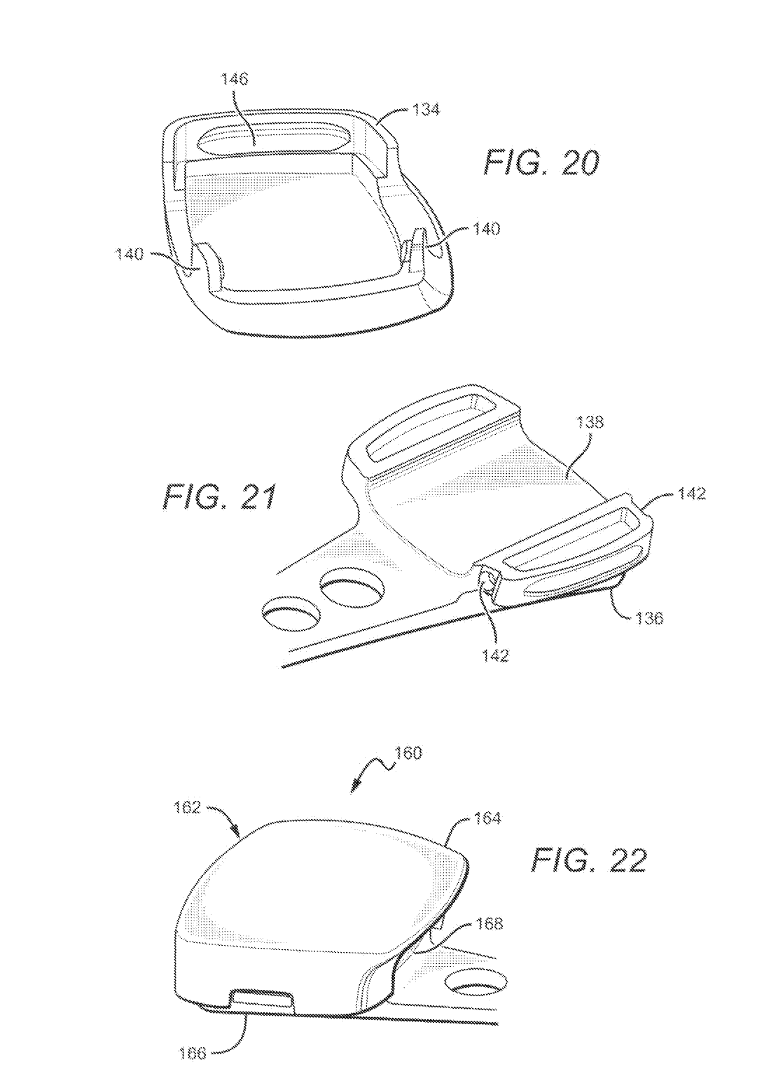

FIGS. 19-21 show another embodiment of a retention device 130 having a housing 132 with upper and lower potions 134, 136 mounted together and forming a channel 138 for the laces. In this embodiment, the upper and lower portions 134, 136 comprise a hinge 138 on one side that allows for the upper portion 134 to rotate about the lower portion 136 between open and closed positions. In this embodiment, the hinge comprises opposing pins 140 in the upper portion 134 that are arranged to be inserted in and engaged with holes 142 in the lower portion 136. It is understood, however, that many different hinge arrangements can be used in different embodiments according to the present invention. The opposite side of the upper and lower portions 134, 136 comprises a ridge 144 and slot 146 arrangement to hold the upper portion 134 in the closed position on the lower portion. In the embodiment shown, the lower portion 136 comprises a ridge, and the upper portion 134 comprises a slot 146, but other embodiments can be arranged in many different ways according to the present invention. The hinge arrangement can help prevent the upper and lower portions from being accidentally knocked apart and can also prevent loss of the upper portion.

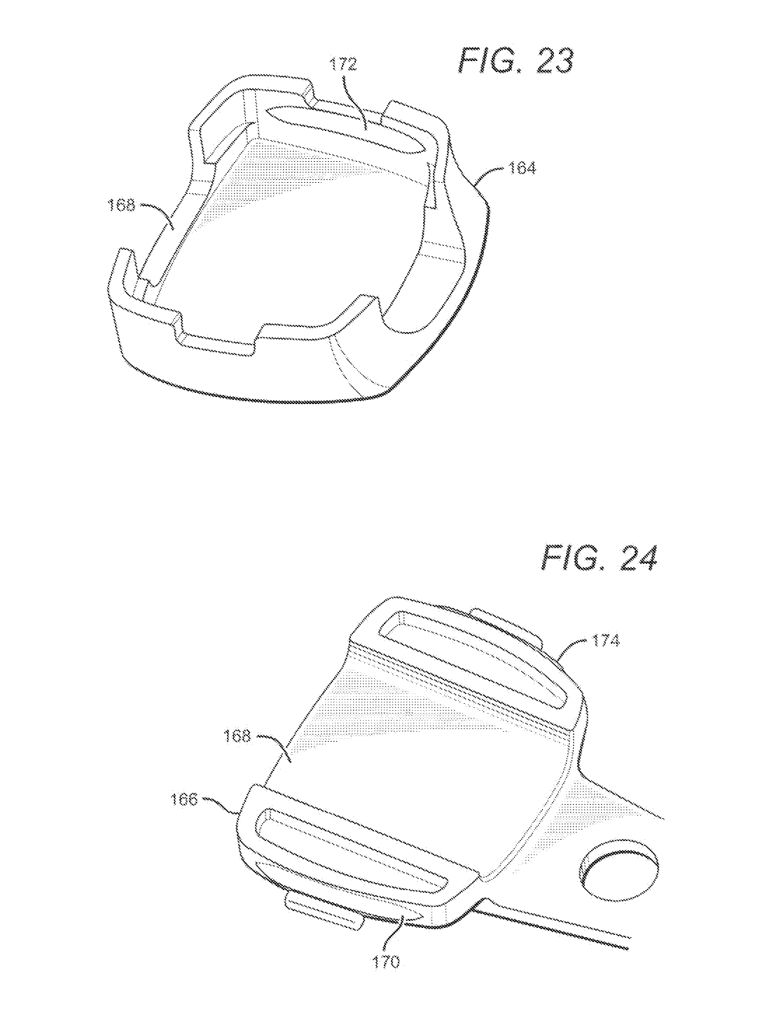

FIGS. 22-24 show still another retention device 160 having a housing 162 with upper and lower potions 164, 166 mounted together and forming a channel 168 for the laces. The upper and lower portions 164, 166 can have a first ridge 170 and first slot 172 arrangement similar to the arrangement in retention device 100 described above. However, instead of having orthogonal second ridges and slots, the retention device 160 comprises second ridge 174 on the lower portion 166 that is parallel the first ridge 172, and is arranged to fit in an indent 176 in the lower portion. This arrangement can also provide improved mounted strength between the upper and lower portions.

The present invention is described herein with reference to certain embodiments, but it is understood that the invention can be embodied in many different forms and should not be construed as limited to the embodiments set forth herein. In particular, the devices can have many different shapes and sizes and can be arranged in many different ways. The devices can also have many different features beyond those shown in the attached drawings and described herein.

I claim:

1. A lace retention device, comprising:
an arm;
a holding mechanism integral to one end of said arm; and
a housing integral to said arm at an end opposite said holding mechanism, said housing being sized and shaped to hold looped footwear laces.

2. The retention device of claim 1, wherein said holding mechanism comprises a hook.

3. The retention device of claim 1, wherein said housing comprises a channel.

4. The retention device of claim 1, wherein said housing comprises an upper and lower portion.

5. The retention device of claim 4, wherein said upper portion can be separated from said lower portion by hand.

6. The retention device of claim 4, wherein said upper portion can snap in place over said lower portion.

7. The retention device of claim 4, further comprising magnets arranged to hold said upper portion to said lower portion.

8. The retention device of claim 4, further comprising a hinge between said upper and lower portions.

9. The retention device of claim 4, wherein said holding mechanism is arranged to engage with a footwear lace.

10. Laced footwear, comprising:
a lace crossed between portions of said footwear to hold said footwear on a foot;
a lace retention device to hold looped portions of said lace, said device comprising:
a holding mechanism to hold said device to one of the crossed sections of said lace; and
a housing coupled to said holding mechanism, said housing having a hollow portion sized and shaped to hold said looped portions of said lace.

11. The laced footwear of claim 1, further comprising an arm between said holding mechanism and said housing/

12. The retention device of claim 11, wherein said holding mechanism comprises a hook.

13. The retention device of claim 11, wherein said housing comprises a channel to hold said looped portions.

14. The retention device of claim 11, wherein said housing comprises an upper and lower portion.

15. The retention device of claim 44, wherein said upper portion can snap in place over said lower portion.

16. The retention device of claim 14, further comprising magnets arranged to hold said upper portion to said lower portion.

17. The retention device of claim 14, further comprising a hinge between said upper and lower portions.

18. A logo display device for mounting to a lace retention device, comprising:
a flat surface for displaying numbers, letters or a logo; and
a mechanism for mounting to a lace retention device on said footwear such that said numbers, letters or logo are visible.
